(19) United States
(12) Patent Application Publication
(10) Pub. No.: US 2015/0200513 A1
(43) Pub. Date: Jul. 16, 2015

(54) METHOD FOR MECHANICALLY AND ELECTRICALLY JOINING ELECTRICAL CONDUCTORS

(71) Applicants: Daniel Isus Feu, Barcelona (ES); Enric Guix Diaz, Barcelona (ES)

(72) Inventors: Daniel Isus Feu, Barcelona (ES); Enric Guix Diaz, Barcelona (ES)

(73) Assignee: GRUPO GENERAL CABLE SISTEMAS, S.A., Barcelona (ES)

(21) Appl. No.: 14/420,107

(22) PCT Filed: Aug. 9, 2012
(86) PCT No.: PCT/ES2012/070620

§ 371 Date: Feb. 6, 2015

(51) Int. Cl. H01R 43/02; B23K 31/02; B23K 1/00

(52) U.S. Cl. CPC H01R 43/0235; B23K 1/0016; B23K 31/02

(57) ABSTRACT

The joining of very long electrical conductors should be more sturdy than what is provided by a simple bush, which joins same when said conductors are to be located on the sea bed in a very irregular manner and with stress on the bush or elevated joining means, a consequence, in addition to the irregularity of the aforementioned, of the great weight of the conductors. For this reason the method that is the aim of the invention consists of welding the conductors, perforating the reinforcement bush, placing same in the welding area of the conductors and welding the bush, and the subsequent deformation of the bush until the diameter of the bush is equal to that of the conductors.

### OBJECT OF THE INVENTION

More specifically the invention refers to a procedure for joining two electrical conductors by welding and subsequent treatment of the joint and the conductors, with the placement of a joining terminal, so that the diameter of the joint, once it is placed in the joint area does not exceed the diameter of the conductors, thus ensuring both the purely mechanical as well as the electrical union.

### STATE OF THE ART

Joining two electrical conductors with the aim of achieving a length of conductor appropriate to needs has been done technologically by using in some instances connectors with pressure screws, so that the ends of the conductors to be joined enter by into the ends of the connectors, and they are immobilised inside by these screws

Another way to join electrical conductors is by welding the ends of the conductors together, which results in an undesirable increase in the diameter of the conductor, which is a problem for subsequent coatings, and with the added difficulty if the conductor needs to slide through a protective cover or tube.

Another way to join is by means of a terminal or connector, formed by a surface which is folded by the action of a press, in this case it presents problems of conductivity and lack of evenness in the joint area with the aforementioned problems of alteration of the diameter in the joint area of the conductors, as it consists in shaping the reinforcement bush with a single impact made by a machine press.

### SCOPE OF THE INVENTION

The aim of the invention is to create a joint between two conductors with the same strength as the original cable, without modifying their mechanical or electrical properties.

The mechanical properties we wish to preserve refer to the requirement that the joining point of the conductors should have the same strength as the conductor without joints, and the electrical properties refer to the fact that the joining point should not negatively affect electrical conductivity throughout the length of the conductor, which would generate heat.

### DESCRIPTION OF THE INVENTION

The installation of conductors for transporting electrical energy, mainly when these conductors travel on the seabed, needs large lengths of conductor that cannot normally be in a single piece, so different sections have to be joined by any known means. However, a conventional joint is not possible, as due to the large diameter of these conductors, they must bear in longitudinal as well as torsional forces, as these conductors are laid on irregular surfaces, bearing their own weight as well, so breakage, apart from being probable, may be a great problem because of where the conductors are located and the difficulty and high cost to access them.

These conductors are laid after they are placed in hoses, the so-called umbilical cable, in which there are other conductors and tubes or not, so that the repair of any breakage under the deep water needs specialised resources and it is difficult to exactly locate the breakage point.

The procedure referred to in the invention begins with the pre-shaping of the surface of a flat plate to obtain, by deformation, a reinforcement bush with the help of mechanical means, such as folding between semi-circular dies in a vice or press located in front of each other, and with decreasing distances between them to cause a deformation from a flat configuration, that of the initial plate, until it becomes cylindrical, but without, closing the edges of the reinforcement bush, leaving a certain alpha angle between them, to allow the later insertion of the welded conductors on the inside of said bush by the space delimited by those edges. The pre-shaping of the surface of the plate can be done by means of clamps, with a cooling circuit, which comes into action when welding the edges of the pre-formed bush longitudinally.

The material of the reinforcement bush will be a flat sheet of conductive metal material, including ferrous, non-ferrous and their alloys, with the same properties as the conductor regarding conductivity, as well as mechanical strength.

Then, once the conductors have been welded co one of their ends, the joint area is surrounded, by means of the previously deformed reinforcement bush, inserting the conductors and terminal and/or connector into it, a second set of clamps or sequence of clamps, each pair with a smaller diameter than the previous, until the edges are free of the reinforcement bush ready for welding, by adding solder to said bush. The last clamp is designed to have the same diameter as the previous one, but it provides the surface of the reinforcement bush with a grooved finish, these clamps, as explained above, have a cooling circuit that acts when the edges of the hush are welded.

On the surface of the reinforcement bush there are a series of grooves that facilitate the subsequent covering of the joint area. In all cases, the procedure described here obtains a diameter in the conductor joint area, which including the thickness of the wall of said reinforcement bush, is of the came dimensions as that of the conductors before they were joined.

Other details and characteristics shall be shown throughout the description below referring to drawings attached to this report which are shown for illustrative but not limiting purposes only in a drawing of the invention.

### BRIEF DESCRIPTION OF THE DRAWINGS

Below is a list of the different parts of the invention, which are indicated in the following drawings with their respective numbers; (10) reinforcement bush, (11) heating and forming workstation, (12) legs, (13) platform, (14) clamps, (15) rod, (16a, 16b) conductors to connect, (17) cavity, (18) edges, (19a, 19b) ends of the conductors, (20) workstation, (21) clamps, (22) welding line.

FIG. 1 is a front elevation view of a reinforcement bush (10) before its modification in shape, from a flat surface to an open cylindrical surface, as can be seen in FIG. 2.

FIG. 2 is a front elevation view of the reinforcement bush (10) of FIG. 1 curved, but with its edges open in an angle alpha.

FIG. 3 is a side elevation view of a heating and forming workstation (11), for joining the conductors (16).

FIG. 4 is a front elevation view and FIG. 4a a top plan view of the heating and forming workstation (11), and with the conductors (16) between the clamps (14).

FIG. 5a is a op plan view of a heating and forming workstation of “A” area before the operation of progressive shaping of the reinforcement bush (10) on the conductors, welded (19a, 19b) inside on the welding area by the action of clamps (14, 21).

FIG. 5b is the same top view as FIG. 5a out when the reinforcement bush (10) has acquired a diameter or section substantially the same as the diameter or section of the welded conductors (16a, 16b), namely when the progressive shaping operation has ended and df (final diameter)=dc (conductor diameter).

### DESCRIPTION OF AN EMBODIMENT OF THE INVENTION

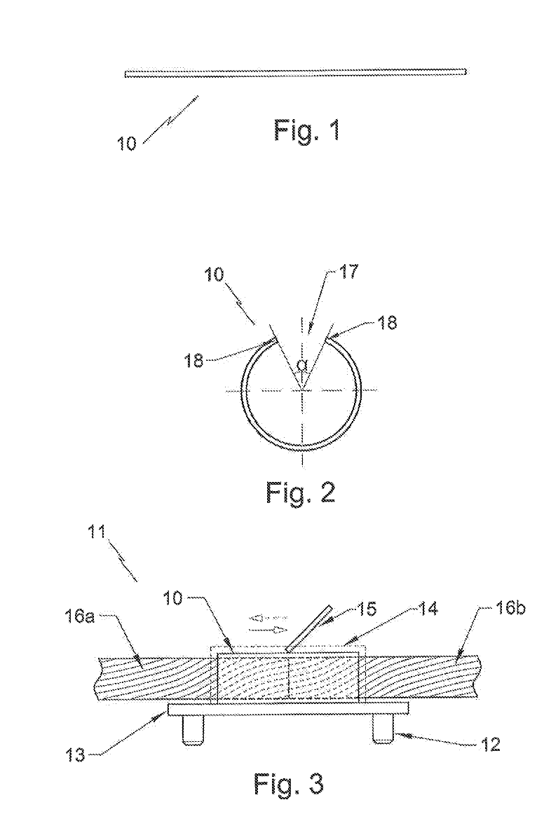

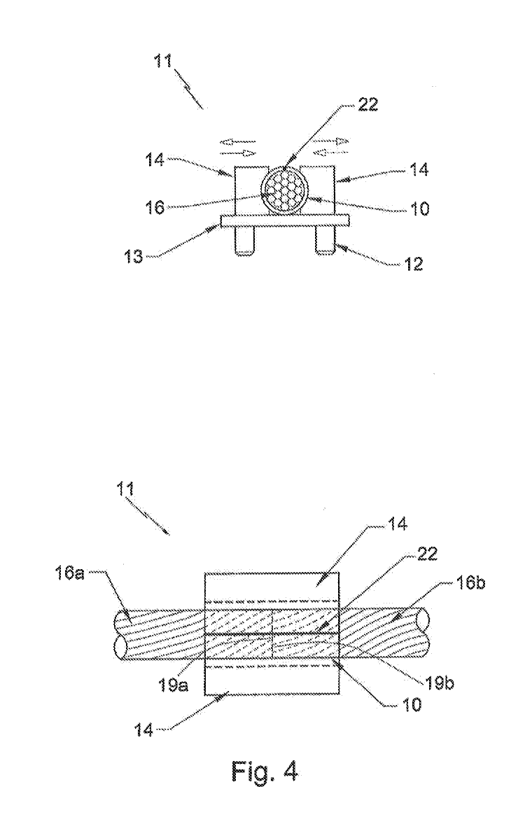

In one of the preferred embodiments of the invention, the procedure described here begins with pre-shaping of the reinforcement bush (10), which, as can be seen in FIG. 1, may be a flat sheet (10) of copper, aluminium, steel or other similar metal with good electrical conductivity or a ferrous or non-ferrous material with its alloys, until it acquires an open cylindrical configuration which is shown in FIG. 2, achieved by the action of semi-circular impressions in mechanical vice or a press or other similar system, not shown in the drawings, so that after die pre-shaping there is angle alpha between the edges (18) of the same, so that subsequently the previously welded conductors (16) can be inserted inside said reinforcement bush (10), in the welding area of the conductors (16).

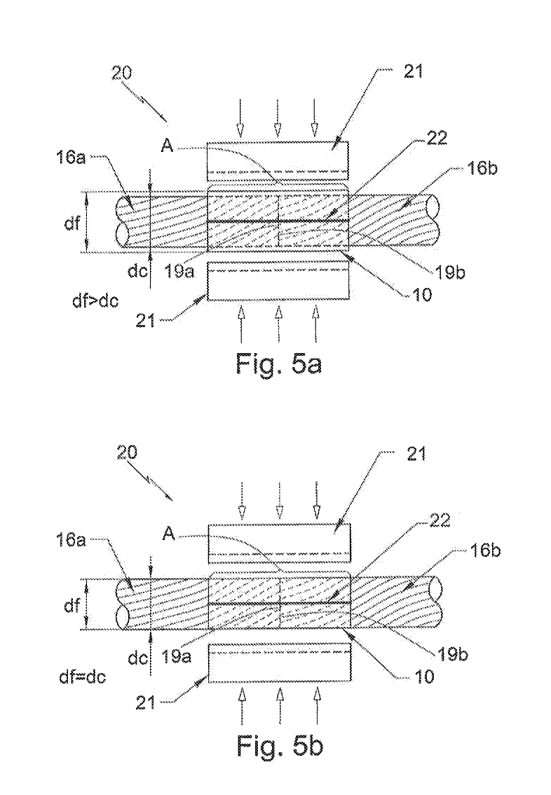

At the same time as the pre-shaping of the sheet (10) to turn it into a bush, there is an operation apart from the welding of the conductors (16) on one of their ends (19), for which their ends (19) are placed in a heating and forming workstation (11), which has clamps (14) opposite each other, the front face of both clamps having a circular open cavity (17) for placing the conductors (16), see FIG. 2, so that when they are clamped (16) between the clamps (14), with a thermal lance or the like, and with solder, the ends (19) are welded and then the reinforcement bush (19) is fitted surrounding the welded area, and starting a circular shaping phase of (10), as can be seen in FIG. 5.

The final shaping of the reinforcement bush (10) is carried out as can be seen in FIG. 5, by means of a second workstation (20) with pairs of opposed clamps (21), with their own cooling circuit (21), each with less distance between each pair of clamps, so that the deformation of the reinforcement bush (10) is progressive longitudinally, and the final diameter of the bush (10) with the conductors (16) in “A” area is the same as the original conductor, finally the bush is welded (10).

The final diameter “df” in the joint area of the two conductors (16), as can be seen in FIG. 5, equal to the diameter of the conductors “dc”, as is shown in FIG. 5, despite the thickness of the reinforcement bush (10) itself. Only when diameters df=dc, may a sheath surrounding and protecting the conductors (16) and the joint area where the reinforcement bush (10) is placed be fitted.

The aforementioned procedure may apply indistinctly to copper and/or aluminium cores, copper aluminium and steel terminals and/or connectors, as well ferrous and non-ferrous materials and their alloys, conductors with individual or multiple wires, LV, MV, HV, EHV cables,

Having sufficiently described this invention using the Figures attached, it is easy to understand that any changes judged to be suitable may be made, whenever these changes do not alter of the essence of the invention summarised in the following claims.

1. A method for mechanically and electrically joining electrical conductors manufactured of copper aluminium, steel or any other electrically conductive material, wherein the method comprises the following phases:
Welding the ends of conductors to be joined.
Pre-shaping of a reinforcement bush, until it becomes cylindrical, leaving an angle between its edges,
Placement of the reinforcement, bush in the welding area of the previously welded conductors,
Welding of the free edges of the reinforcement bush with the conductors welded inside,
Progressive shaping of the terminal and/or connector with the conductors welded inside on the welding area of the conductors until they achieve diameter df=dc.

2. The method for mechanically and electrically joining electrical conductors according to claim 1, wherein the pre-shaping of a reinforcement bush from a flat sheet is done by means of semi-circular dies in a vice or press.

3. The method for mechanically and electrically joining electrical conductors according to claim 1, wherein the welding of the ends of the conductors to be joined is done with the help of clamps the inboard face of which have a circular recess, and are heated, welding the ends by adding solder and a heat lance or the like to the ends.

4. The method for mechanically and electrically joining electrical conductors according to claim 1, wherein the welding of the edges of the reinforcement bush is carried out in longitudinal direction in the whole of “A” area.

5. The method for mechanically and electrically joining electrical conductors according to claim 1, wherein the progressive shaping of the terminal, and/or connector before fitting the welded conductors, semi-circular dies will be used in a mechanical vice or press.

6. The method for mechanically and electrically joining electrical conductors according to claim 1, wherein for welding the conductors on one of their ends, a heating and forming workstation is used, which has clamps opposite each other, the front face of both clamps having a circular open cavity for placing the conductors, so that when they are clamped between the clamps, with a thermal lance or the like, and with solder, the ends are welded and then the reinforcement bush is fitted surrounding the welded area.

7. The method for mechanically and electrically joining electrical conductors according to claim 1, wherein once the soldered conductors are placed in the terminal, and/or connector, a second workstation will be used for its final until folding so the edges fold as much as possible, this will have a pair of opposed clamps, each with less distance between each pair of clamps, so that the deformation of the reinforcement bush is progressive longitudinally, and the final diameter of the bush with the conductors in “A” area is the same as the original conductor, finally the bush is welded.

8. The method for mechanically and electrically joining electrical conductors according to claim 7, wherein the clamps will have a cooling circuit which acts at the moment of welding the edges of the reinforcement bush.
